(19) United States
(12) Patent Application Publication
(10) Pub. No.: US 2015/0067510 A1
(43) Pub. Date: Mar. 5, 2015

(54) DISPLAY SYSTEM, RECORDING MEDIUM, AND SELECTION CONTROL METHOD

(71) Applicants: Hidenobu HASHIKAMI, Kanagawa (JP); Osamu OGAWARA, Kanagawa (JP)

(72) Inventors: Hidenobu HASHIKAMI, Kanagawa (JP); Osamu OGAWARA, Kanagawa (JP)

(73) Assignee: Ricoh Company, Ltd., Tokyo (JP)

(21) Appl. No.: 14/452,810

(22) Filed: Aug. 6, 2014

(30) Foreign Application Priority Data
Sep. 2, 2013 (JP) 2013-181154

(51) Int. Cl. G06F 3/0482; H04L 29/08

(52) U.S. Cl. CPC G06F 3/0482; H04L 67/10
USPC 715/716

(57) ABSTRACT

A display system includes a display device and an information terminal adapted to communicate with the display device. The information terminal includes a processor and a storage part storing instructions which when executed by the processor cause the processor to perform a process including determining whether content data stored in the storage part is capable of being played back on the display device based on information associated with playback capability of the content data on the display device; displaying a list screen of identification information items of content data when the content data is determined as being capable of being played back on the display device; and transmitting, to the display device, content data corresponding to identification information items which are selected from the list screen displayed.

### BACKGROUND OF THE INVENTION

1. Field of the Invention

The present invention generally relates to the field of selection control. More particularly, the present invention relates to a display system, a recording medium, and a selection control method which are adapted to control selection of content data to be played back on a display device.

2. Description of the Related Art

Conventionally, display systems in which content data selected on an information terminal is supplied to a display device and the content data is played back on the display device are known.

For example, among the conventional systems, the following technology is known. In this technology, when a playback request of content data selected on the information terminal is made, it is determined whether the selected content data is capable of being played back on the display device. If it is determined that the selected content data is incapable of being played back on the display device, a warning message is output to the information terminal. For example, see Japanese Laid-Open Patent Publication No. 2010-232760.

In the case of the above-described technology, the determination as to whether content data is capable of being played back on the display device cannot be made until the content data is selected on the information terminal. Hence, in the conventional technology, even if a user selects desired content data and makes a playback request of the selected content data, there may be a case in which the selected content data is incapable of being played back on the display device. In such a case, the user may be required to perform an operation for selecting other content data. Hence, the user must perform a repetitive operation.

### SUMMARY OF THE INVENTION

In one aspect, the present invention provides a display system, a recording medium, and a selection control method which are adapted to supply increased operability in selection of content data to be played back on a display device.

In an embodiment which solves or reduces one or more of the above-described problems, the present invention provides a display system including a display device and an information terminal adapted to communicate with the display device, the information terminal including a processor and a storage part storing instructions which when executed by the processor cause the processor to perform a process including: determining whether content data stored in the storage part is capable of being played back on the display device based on information associated with playback capability of the content data on the display device; displaying a list screen of identification information items of content data when the content data is determined as being capable of being played back on the display device; and transmitting, to the display device, content data corresponding to identification information items which are selected from the list screen displayed.

Other objects, features and advantages of the present invention will become more apparent from the following detailed description when read in conjunction with the accompanying drawings.

### BRIEF DESCRIPTION OF THE DRAWINGS

FIG. 1 is a diagram showing an overall configuration of a display system according to a first embodiment.

FIG. 2 is a diagram for explaining a scenario in which the display system according to the first embodiment is utilized.

FIG. 3 is a diagram showing a hardware configuration of each of an information terminal and a display device of the display system.

FIG. 4 is a diagram showing a functional configuration of each of the information terminal and the display device of the display system.

FIG. 5 is a sequence diagram for explaining operation of the display system according to the first embodiment.

FIG. 6 is a flowchart for explaining a list screen display process performed by the information terminal.

FIG. 7 is a diagram showing an example of a list screen displayed on the information terminal.

FIG. 8 is a diagram showing another example of the list screen displayed on the information terminal.

FIG. 9 is a flowchart for explaining a list screen display process performed by an information terminal of a display system according to a second embodiment.

FIG. 10 is a diagram showing an example of a list screen displayed on the information terminal of the display system.

FIG. 11 is a diagram showing another example of the list screen displayed on the information terminal of the display system.

FIG. 12 is a diagram showing a functional configuration of each of an information terminal, a display device, and a playback capability information provision server of a display system according to a third embodiment.

### DETAILED DESCRIPTION OF THE PREFERRED EMBODIMENTS

A description will be given of embodiments with reference to the accompanying drawings.

In a display system according to one embodiment, content data that is determined as being capable of being played back on a display device is displayed in a content data list screen on an information terminal, and it is possible to supply increased operability in selection of the content data.

### First Embodiment

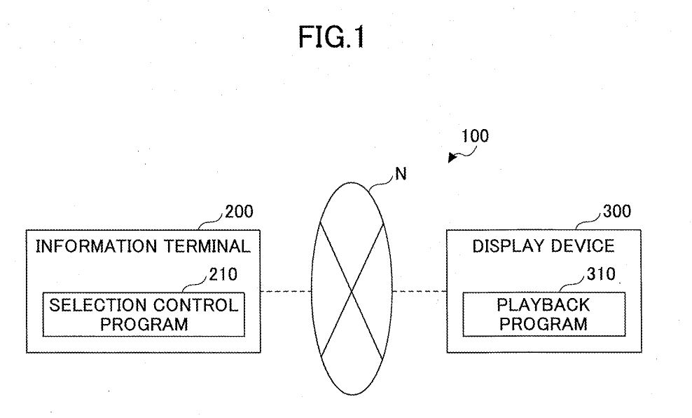

A display system according to a first embodiment is explained. FIG. 1 shows an overall configuration of a display system 100 according to the first embodiment.

The display system 100 includes an information terminal 200 and a display device 300. In the display system 100, the information terminal 200 and the display device 300 are connected via a data transmission path N such as a network, so that the information terminal 200 and the display device 300 communicate with each other.

The information terminal 200 may perform communication according to a communication protocol complying with the communication standard such as 3G (3rd Generation), LTE (Long Term Evolution) or 4G (4th Generation). Moreover, the information terminal 200 may perform communication according to another communication protocol such as ZigBee or Bluetooth®.

The information terminal 200 may be implemented by a wireless communication terminal, such as a smart phone or a mobile phone. Moreover, the information terminal 200 may be implemented by a tablet PC (personal computer) or a notebook PC. The information terminal 200 may be adapted to communicate with the display device 300.

A selection control program 210 is installed in the information terminal 200. The selection control program 210 when executed by a processor of the information terminal 200 causes the processor to transmit to the display device 300 content data selected on the information terminal 200 and playback control information which will be described later.

A playback program 310 is installed in the display device 300. The playback program 310 when executed by a processor of the display device 300 causes the processor to display the content data received from the information terminal 200 based on the playback control information.

The display device 300 may be adapted to have a display function to display the content data based on the playback control information received from the information terminal 200. The display device 300 may be implemented by a projector or a display unit.

In the following, operation of the display device 300 to display the content data based on the playback control information is expressed as playback of the content data.

Moreover, the content data may be implemented by image data or video data. The image data used as the content data may be image data indicating a single image or may be image data indicating two or more images. The content data may be implemented by any image data that is capable of being displayed or played back on the display device 300.

In the following, content data which is transmitted from the information terminal 200 to the display device 300 and played back on the display device 300 is called “playback content data”. In other words, the playback content data is the content data selected on the information terminal 200 in order to transmit the same to the display device 300. Moreover, in the following, two or more items of content data stored in a predetermined storage area are called “content data”, and content data included in content data is also called “content data”.

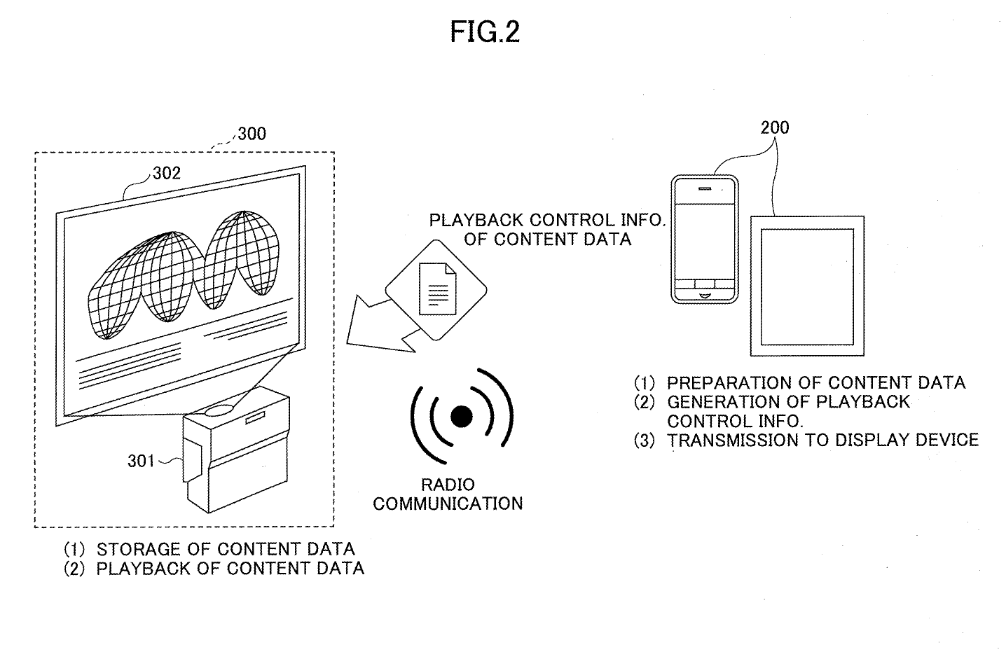

Next, a scenario in which the display system 100 according to the first embodiment is utilized is explained with reference to FIG. 2. FIG. 2 is a diagram for explaining a scenario in which the display system 100 is utilized.

In the example of FIG. 2, it is assumed that the information terminal 200 is a smart phone or a tablet PC, the display device 300 is configured to include a projector 301 and a screen 302, and the display system 100 is utilized as a digital signage system.

If desired content data is selected by a user on the information terminal 200 and a playback setting of the selected content data (playback content data) is input by the user, the information terminal 200 generates the playback control information of the selected content data based on the playback setting. Subsequently, the information terminal 200 transmits the playback content data and the playback control information to the projector 301. The projector 301 stores the received playback content data in a storage part 32 (which will be described later) and plays back the playback content data based on the playback control information.

In this way, in the display system 100, if the playback content data and the playback control information are transmitted to the display device 300, the user may continuously reproduce the playback content data based on the desired playback setting. Namely, when the display system 100 is utilized as a digital signage system, the content data is automatically played back based on the user's desired playback setting, and it is no longer necessary for the user to spend the time and effort for setting up the sequence of playback of the content data or the switching between display indications on an as-needed basis.

Moreover, in this embodiment, a list of identification information items of playback-capable content data which are capable of being played back on the display device 300 is displayed in a content data list screen on the information terminal 200. Specifically, the information terminal 200 receives information associated with the playback capability of the display device 300 from the display device 300 and compares the information associated with the playback capability with attribute information of each of the content data stored in the storage area 220. The information terminal 200 determines the content data with which the information associated with the playback capability and the attribute information are in agreement as being the playback-capable content data which is capable of being played back on the display device 300. Subsequently, the information terminal 200 displays the list of identification information items of the playback-capable content data that is capable of being played back as a content data list screen.

In this embodiment, all the content data selected on the information terminal 200 is the playback-capable content data on the display device 300. Therefore, it is no longer necessary for the user to perform an operation of selecting other content data when the selected content data is incapable of being played back, and it is possible to supply increased operability in selection of the content data. The information associated with the playback capability of the display device 300 and the attribute information of the content data will be described later.

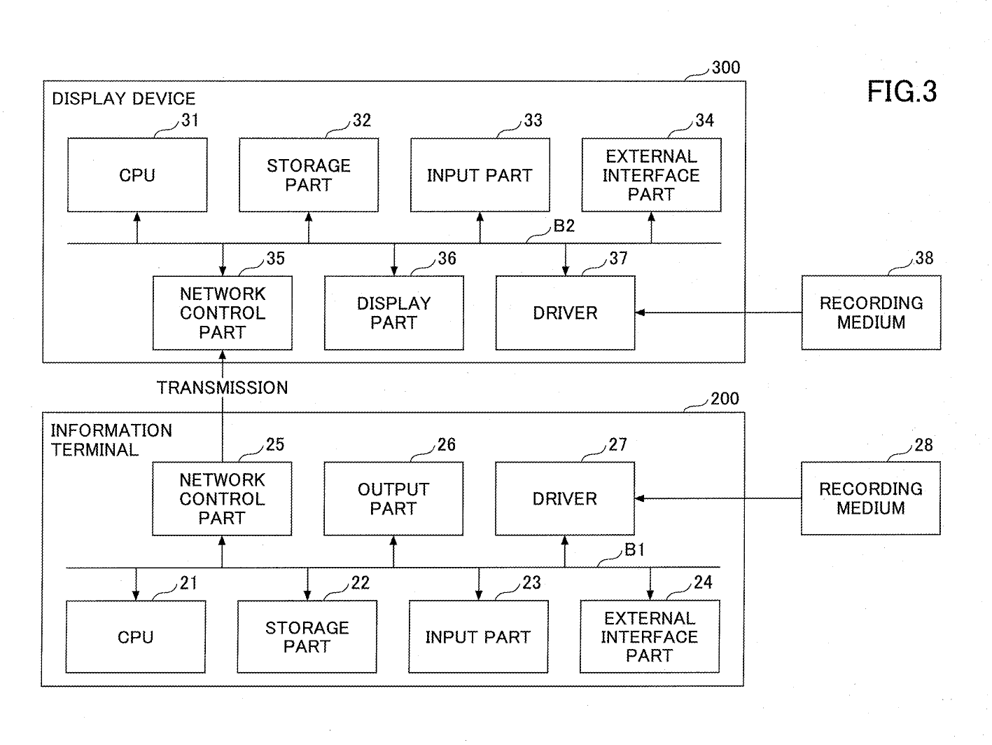

Next, a hardware configuration of the display system 100 is explained with reference to FIG. 3. FIG. 3 shows a hardware configuration of each of the information terminal 200 and the display device 300 of the display system 100.

As shown in FIG. 3, the information terminal 200 includes a CPU (central processing unit) 21, a storage part 22, an input part 23, an external interface part 24, a network control part 25, an output part 26, and a driver 27. These components of the information terminal 200 are interconnected by a bus B1.

The CPU 21 is configured to control overall operations of the information terminal 200. The storage part 22 is configured to store various programs including the selection control program 210 executed by the CPU 21 and various information items associated with operations and computations of the information terminal 200. The input part 23 is configured to receive various signals and information items input by a user. The input part 23 may be configured to have a display functions, such as a touch panel function. Moreover, the input part 23 may be implemented by a pointing device or a keyboard.

The external interface part 24 may be implemented by a USB (universal serial bus) memory slot or an NFC (near field communication) module. The network interface part 25 is configured to include a modem or a LAN (local area network) card and used to connect the information terminal 200 to the network. The output part 26 is configured to output various information items from the information terminal 200 to the outside. The output part 26 may be implemented by a display unit, or may be implemented by a transmission unit to transmit various data items to an external device.

The selection control program 210 is at least a part of the various programs stored to control the information terminal 200. The selection control program 210 is supplied to the information terminal 200 by distribution of a recording medium 28 or by downloading the selection control program 210 from the network. Examples of the recording medium 28 in which the selection control program 210 is recorded include a CD-ROM, a flexible disk, a magneto-optical disk, a ROM, a flash memory, etc.

If the recording medium 28 in which the selection control program 210 is recorded is set to the driver 27, the selection control program 210 from the recording medium 28 is installed in the storage part 22 through the driver 27. If the selection control program 210 is downloaded from the network, the selection control program 210 is installed in the storage part 22 through the network control part 25.

The storage part 22 is configured to store necessary files and data items as well as the various programs including the installed selection control program 210. The selection control program 210 when read from the storage part 22 and executed by the CPU 21 causes the CPU 21 to perform various processes which will be described later.

Moreover, as shown in FIG. 3, the display device 300 includes a CPU 31, a storage part 32, an input part 33, an external interface part 34, a network control part 35, a display part 36, and a driver 27. These components of the display device 300 are interconnected by a bus B2.

The CPU 31 is configured to control overall operations of the display device 300. The storage part 32 is configured to store various programs including the playback program 310 executed by the CPU 31, various information items associated with operations and computations of the display device 300, and the playback content data to be played back on the display device 300. The input part 33 is configured to receive various signals and information items input by a user. The input part 33 may be implemented by an operating unit to operate the display device 300.

The external interface part 34 may be implemented by a USB memory slot or an NFC module. The network control part 35 is configured to connect the display device 300 to the network. The display part 36 is configured to display or play back the playback content data on the display device 300 in accordance with a received playback instruction specifying the playback content data.

The playback program 310 is at least a part of the various programs stored to control the display device 300. The playback program 310 is supplied to the display device 300 by distribution of a recording medium 38 or by downloading the playback program 310 from the network.

If the recording medium 38 in which the playback program 310 is recorded is set to the driver 37, the playback program 310 from the recording medium 38 is installed in the storage part 32 through the driver 37. If the playback program 310 is downloaded from the network, the playback program 310 is installed in the storage part 32 through the network control part 35.

The storage part 32 is configured to store necessary files and data items including the playback content data as well as the installed playback program 310. The playback program 310 when read from the storage part 32 and executed by the CPU 31 causes the CPU 31 to perform various processes which will be described later.

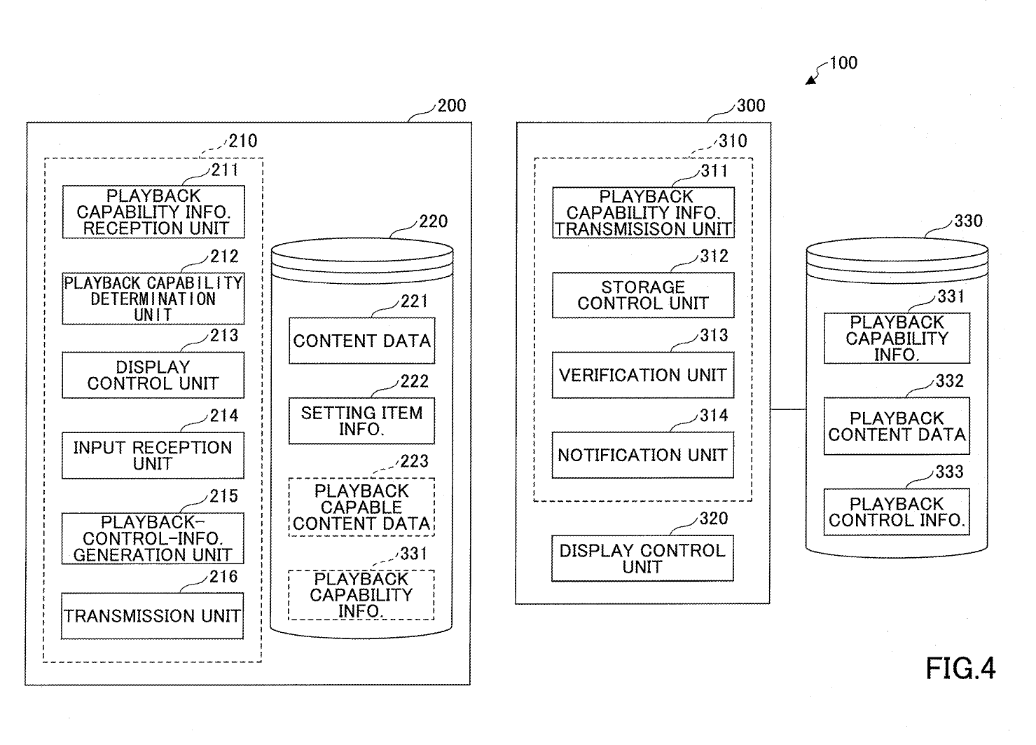

Next, a functional configuration of the display system 100 is explained with reference to FIG. 4. FIG. 4 shows a functional configuration of each of the information terminal 200 and the display device 300 of the display system 100.

As shown in FIG. 4, the information terminal 200 includes a predetermined storage area 220 which is provided in the storage part 22. For example, content data 221 and setting item information 222 are stored in the storage area 220. The content data 221 may be image data or video data that is capable of being played back on the display device 300. The content data 221 may include two or more content data items, or may include one content data item.

The setting item information 222 may be information that indicates setting items input by the user when generating the playback control information.

Moreover, the information terminal 200 is configured so that, through a later-described process, the information terminal 200 temporarily stores, in the storage area 220, playback-capable content data 223 determined as being capable of being played back on the display device 300.

When a playback capability information reception unit 211 which will be described later receives playback capability information 331 from the display device 300, the information terminal 200 stores the received playback capability information 331 in the storage area 220.

As shown in FIG. 4, the information terminal 200 includes a playback capability information reception unit 211, a playback capability determination unit 212, a display control unit 213, an input reception unit 214, a playback-control-information generation unit 215, and a transmission unit 216.

The playback capability information reception unit 211 is configured to send a reception request of the playback capability information 331 to the display device 300, receive the playback capability information 331 from the display device 300, and store the playback capability information 331 in the storage area 220.

The playback capability determination unit 212 is configured to determine whether the content data 221 is capable of being played back on the display device 300 based on the playback capability information 331. Specifically, the playback capability determination unit 212 receives the attribute information of the content data 221 and compares the attribute information with the playback capability information 331. The playback capability determination unit 212 determines the content data 221 as being capable of being played back on the display device 300 if a file type and a file format of the content data 221 included in the attribute information are included in the playback capability information 331.

The playback capability determination unit 212 is configured to temporarily store the content data 221, which is determined as being capable of being played back on the display device 300, in the storage area 220 as the playback-capable content data 223. The playback-capable content data 223 may include two or more content data items or may include one content data item.

The display control unit 213 is configured to display a list screen of identification information items of the playback-capable content data 223 on the display part which is the output unit 26 of the information terminal 200. Moreover, the display control unit 213 is configured to display a setting screen for inputting values of setting items included in the setting item information 222 by a user.

For example, the identification information items of the playback-capable content data 223 may be thumbnail images when the content data is image data or video data, or may be file names of the content data. It is adequate for the identification information items of the content data to be information that identifies the content data.

The input reception unit 214 is configured to receive selection of all or a part of the content data 221 in the list screen of the identification information items of the playback-capable content data 223. In this embodiment, the content data 221 which is selected in the list screen and to which a transmission request is made is transmitted from the information terminal 200 to the display device 300 as playback content data 332.

Moreover, the input reception unit 214 is configured to receive values of the setting items which are input to the setting screen by the user, the setting screen being displayed on the information terminal 200 for inputting the values of the setting items included in the setting item information 222.

The playback-control-information generation unit 215 is configured to generate playback control information 333 based on information included in the selected playback content data 332. For example, the playback control information 333 contains a setting item indicating a sequence of playback of items of the content data 221 included in the playback content data 332, a setting item indicating a playback time of each of the items of the content data 221 included in the playback content data 332, and a setting item indicating how to switch between display indications of each of the items of the content data 221 included in the playback content data 332.

In this embodiment, a value of a predetermined setting item included in the playback control information 333 is set to a value of the predetermined setting item input to the setting screen by the user. The predetermined setting item may include the playback sequence setting item, the playback time setting item, and the switching effect setting item of the content data 221 contained in the playback content data 332.

The playback-control-information generation unit 215 may be configured to cause, when the playback content data 332 is selected in the list screen, the display control unit 213 to display the setting screen of the predetermined setting items described above, and generate the playback control information 333 based on the input values of the predetermined setting items. Moreover, the playback-control-information generation unit 215 may be configured to store the values of the predetermined setting items input by the user in an arbitrary timing, and generate, when the playback content data 332 is selected, the playback control information 333 by using the stored values of the predetermined setting items. The playback control information 333 is associated with the playback content data 332 and transmitted to the display device 300.

The transmission unit 216 is configured to transmit the playback control information and the playback content data 332 to the display device 300.

In this embodiment, the information terminal 200 includes the storage part 22 in which the content data 221 is stored in the storage area 220. The present disclosure is not limited to this embodiment. For example, the content data 221 may be stored in a removable recording medium which is readable by the processor of the information terminal 200. Alternatively, the content data 221 may be stored in an external device which is adapted to communicate with the information terminal 200.

Moreover, as shown in FIG. 4, the display device 300 includes a playback capability information transmission unit 311, a storage control unit 312, a verification unit 313, and a notification unit 314. Moreover, the display device 300 includes a display control part 320 which is configured to control the display of the display part 36.

Furthermore, the display device 300 includes a storage area 330 in which the playback capability information 331, the playback content data 332, and the playback control information 333 are stored.

The playback capability information 331 is information associated with the playback capability of the content data by the display device 300. For example, the playback capability information 331 indicates a file type and a file format of the content data which is capable of being played back on the display device 300. Specifically, the playback capability information 331 includes a file type of playback-capable image data or audio data, and a bit rate, a codec, a resolution, etc. of video data, which are capable of being played back on the display device 300.

The playback content data 332 and the playback control information 333 are information received at the display device 300 from the information terminal 200.

The storage area 330 may be provided in the storage part 32 of the display device 300, or may be provided in a removable recording medium which is readable by the display device 300. Alternatively, the storage area 330 may be provided in an external device which is adapted to communicate with the display device 300.

The playback capability information transmission unit 311 is configured to read the playback capability information 331 from the storage area 330 in response to a reception request of the playback capability information 331 from the information terminal 200, and transmit the playback capability information 331 to the information terminal 200.

The storage control unit 312 is configured to store in the storage area 330 the playback content data 332 and the playback control information 333 which are received from the information terminal 200. Moreover, the storage control unit 312 is configured to set up the values of the setting items included in the playback control information 333 to the display device 300 when a playback instruction of the playback content data 332 is received from the information terminal 200.

The verification unit 313 is configured to determine whether the playback content data 332 is capable of being played back on the display device 300 based on the playback control information 333. The details of a verification process performed by the verification unit 313 will be described later. The notification unit 314 is configured to send a notification indicating a verification result from the verification unit 313 to the information terminal 200.

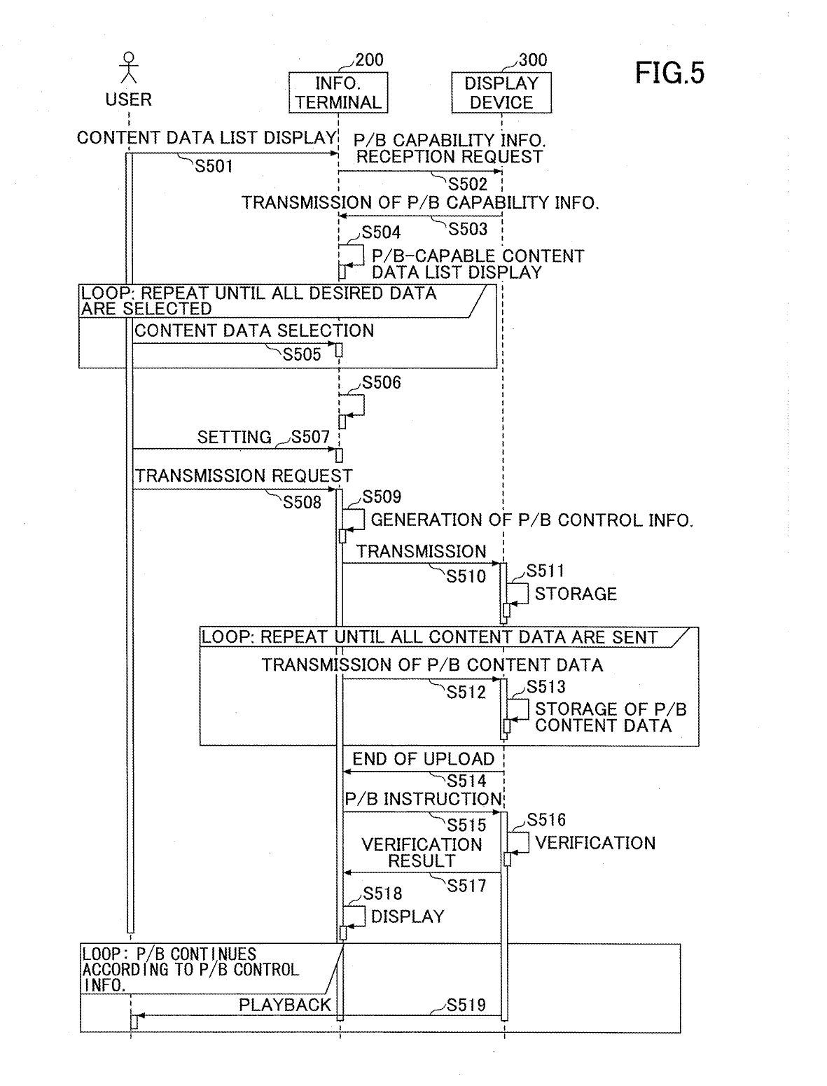

Next, operation of the display system 100 according to this embodiment is explained with reference to FIG. 5. FIG. 5 is a sequence diagram for explaining operation of the display system 100.

As shown in FIG. 5, if a user inputs a content data list display instruction of the content data 221 and the content data list display instruction is received by the information terminal 200 (step S501), the information terminal 200 starts the selection control program 210 and receives the playback capability information 331.

Specifically, the information terminal 200 transmits a reception request of the playback capability information 331 to the display device 300 (step S502). In response to this reception request, the display device 300 causes the playback capability information transmission unit 311 to transmit the playback capability information 331 to the information terminal 200 (step S503). For example, in this embodiment, the playback capability information 331 may be included in SSID (service set identifier) of the display device 300 and transmitted to the information terminal 200. Namely, the information terminal 200 receives the playback capability information 331 when a connection between the information terminal 200 and the display device 300 is established.

When the playback capability information 331 is received from the display device 300, the information terminal 200 displays the list screen of the identification information items of the playback-capable content data 223 included in the content data 221 (step S504). The details of the content data list screen display process at step S504 will be described later.

Subsequently, the information terminal 200 causes the input reception unit 214 to receive selection of the content data 221 in the list screen (step S505). The content data 221 selected here is the content data contained in the playback-capable content data 223.

After the content data 221 is selected, the information terminal 200 sends a notification indicating the reception of the selection to the user (step S506). The details of the notification to the user here will be described later.

In this embodiment, the processing of steps S505 and S506 is repeated until the selection operation of the content data 221 by the user is completed.

Subsequently, the information terminal 200 displays the setting screen for inputting the values of the predetermined setting items of the playback control information 333, and causes the input reception unit 214 to receive the input values of the predetermined setting items (step S507). The input values of the predetermined setting items are associated with the corresponding setting items and stored.

Subsequently, if a transmission request of the playback content data 332 input by the user is received (step S508), the information terminal 200 causes the playback-control-information generation unit 215 to generate the playback control information 333 (step S509). Specifically, if a transmission request is received, the playback-control-information generation unit 215 substitutes the stored values of the setting items into a predetermined format and generates the playback control information 333.

Subsequently, the information terminal 200 causes the transmission unit 216 to transmit the playback control information 333 to the display device 300 (step S510).

After the playback control information 333 is received from the information terminal 200, the display device 300 causes the storage control unit 312 to store the playback control information 333 in the storage area 330 (step S511).

Subsequently, the information terminal 200 reads the content data 221, which is selected from the list screen displayed at step S504, and causes the transmission unit 216 to transmit the selected content data 221 to the display device 300 as the playback content data 332 (step S512). After the playback content data 332 is received from the information terminal 200, the display device 300 causes the storage control unit 312 to store the playback content data 332 in the storage area 330 (step S513).

In this embodiment, for example, a folder associated with the information terminal 200 may be provided in the storage area 330 of the display device 300, and the playback content data 332 and the playback control information 333 may be stored in this folder.

Subsequently, the display device 300 causes the notification unit 314 to send to the information terminal 200 a notification indicating that storage (uploading) of the playback content data 332 into the storage area 330 is finished (step S514).

After the notification is received from the display device 300, the information terminal 200 transmits a playback instruction of the playback content data 332 to the display device 300 (step S515). After the playback instruction is received from the information terminal 200, the display device 300 sets up the values of the setting items included in the playback control information 333 to the display device 300 so that the playback content data 332 may be played back according to the playback control information 333.

Moreover, after the playback instruction is received, the display device 300 causes the verification unit 313 to determine whether the playback content data 332 is capable of being played back on the display device 300 based on the playback control information 333 (step S516).

Subsequently, the display device 300 causes the notification unit 314 to send a notification indicating a verification result from the verification unit 313 to the information terminal 200 (step S517). Specifically, when it is determined at step S516 that the playback content data 332 is capable of being played back on the display device 300, the notification unit 314 may send to the information terminal 200 a notification indicating that the transmission of the content data has been performed successfully. After the notification is received from the notification unit 314, the information terminal 200 displays a result of the verification (step S518).

On the other hand, when it is determined at step S516 that the playback content data 332 is incapable of being played back on the display device 300, the notification unit 314 may send to the information terminal 200 a notification indicating that the transmission of the content data has failed. For example, the playback content data 332 is determined as being incapable of being played back on the display device 300 when path information indicating a storing position of the content data 221 is not included in the playback control information 333 or when the playback control information 333 is in a format which is not readable by the display device 300.

In this embodiment, when the transmission of the content data has failed, a message requesting the user to re-transmit the playback content data 332 may be displayed on the information terminal 200.

After step S518 is performed, the display device 300 plays back the playback content data 332 based on the playback control information 333 (step S519).

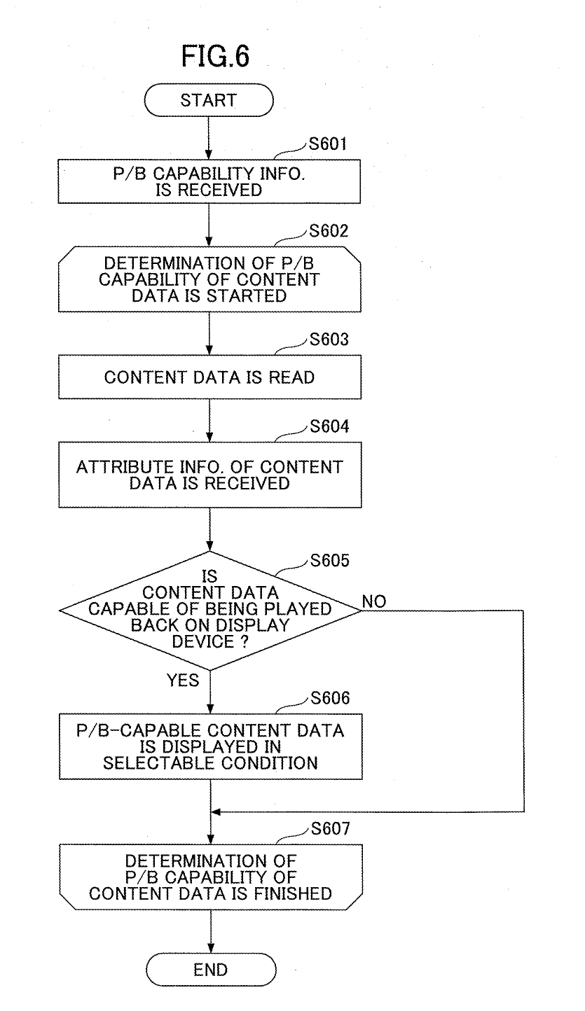

Next, the content data list screen display process performed at step S504 in the sequence diagram of FIG. 5 is explained with reference to FIG. 6. FIG. 6 is a flowchart for explaining the content data list screen display process performed by the information terminal 200.

As shown in FIG. 6, after the playback capability information 331 is received from the display device 300 (step S601), the information terminal 200 starts performing the determination as to whether the content data is capable of being played back on the display device 300 with respect to all the items of the content data 221 stored in the storage area 220 (step S602).

The playback capability determination unit 212 reads the content data 221 from the storage area 220 (step S603). Subsequently, the playback capability determination unit 212 receives the attribute information of the read content data 221 (step S604).

Here, the attribute information of the content data is explained. For example, the attribute information of the content data 221 may include items, such as a file name of the content data 221, a file type, a file format, a storing position of the content data 221, a file size, and an update date and time of the content data 221. Moreover, when the content data 221 is video data, the attribute information thereof may include a bit rate, a codec, a resolution, etc. of the video data.

After step S604 is performed, the playback capability determination unit 212 compares the playback capability information 331 with the attribute information of the read content data 221, and determines whether the content data 221 is capable of being played back on the display device 300 (step S605).

Specifically, the playback capability determination unit 212 determines whether a file type and a file format of the content data 221 indicated by the attribute information received at step S604 are in agreement with a file type and a file format included in the playback capability information 331.

When the file type and the file format of the content data 221 are in agreement with those included in the playback capability information 331, the playback capability determination unit 212 determines that the content data 221 read at step S603 is capable of being played back on the display device 300. On the other hand, when the file type and the file format of the content data 221 and the playback capability information 331 are not in agreement, the playback capability determination unit 212 determines that the content data 221 is incapable of being played back on the display device 300.

When it is determined at step S605 that the content data 221 is capable of being played back (YES in step S605), the display control unit 213 temporarily stores the content data 221 in the storage area 220 as the playback-capable content data 223, and displays the list screen of the identification information items of the content data 221 (step S606). In this case, the display control unit 213 displays the list screen of the identification information items of the content data 221 in a selectable condition in which the identification information items in the list screen are selectable by the user.

When the list screen of the content data 221 is displayed in the selectable condition, a user's touch on one of the identification information items of the content data 221 in the list screen displayed in the viewing area is detected as a selection instruction of a corresponding item of the content data 221. However, the present disclosure is not limited to detection of a user's contact. For example, another operation which is performed by the user with a pointing device or the like on the viewing area in which the identification information items of the content data 221 are displayed may be detected as a selection instruction of a corresponding item of the content data 221.

On the other hand, when it is determined at step S605 that the content data 221 is incapable of being played back (NO in step S605), the playback capability determination unit 212 sets the identification information items of the content data 221 read at step S603 in a non-display condition, and the determination of the playback capability of the content data 221 in the display process shown in FIG. 6 is finished (step S607).

The processing of steps S602 to S607 performed by the playback capability determination unit 212 and the display control unit 213 in the information terminal 200 is repeated for all the content data 221 stored in the storage area 220.

As a result, the list screen of the identification information items of the playback-capable content data 223 which is capable of being played back on the display device 300 is displayed on the information terminal 200.

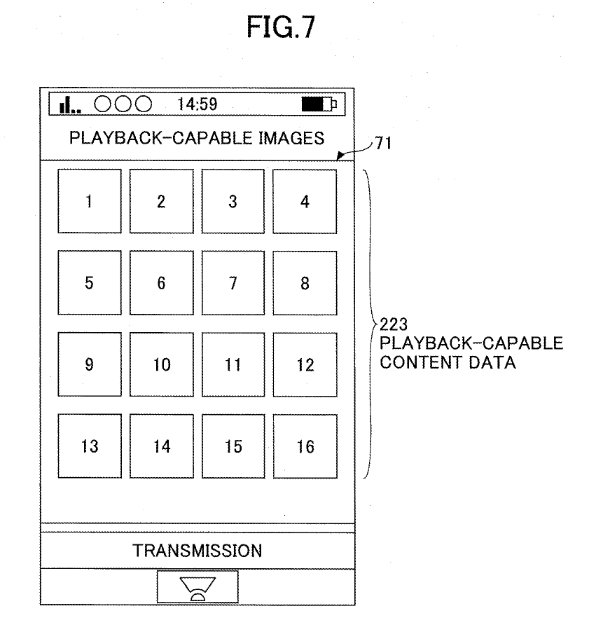

FIG. 7 shows a list screen 71 displayed on the information terminal 200.

As shown in FIG. 7, in the list screen 71, only the identification information items of the playback-capable content data 223, which are determined as being capable of being played back on the display device 300 in the display process of FIG. 6, are displayed. In the example of FIG. 7, the identification information items of the content data 223 are implemented by thumbnail images of the playback-capable content data 223.

Alternatively, when the identification information items of the playback-capable content data 223 are implemented by file names of the playback-capable content data, a list of file names may be displayed in the list screen 71.

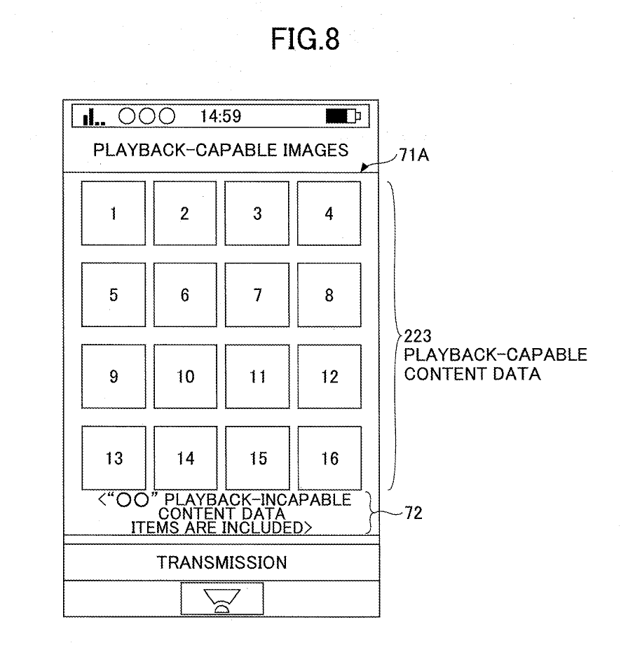

FIG. 8 shows a list screen 71A displayed on the information terminal 200.

In the list screen 71A shown in FIG. 8, a list of the identification information items of the playback-capable content data 223 and a message 72 indicating the presence of playback-incapable content data 221, which are determined as being incapable of being played back on the display device 300, are displayed. In this case, when there are some items of the content data 221 determined as being incapable of being played back, the message 72 may indicate the number of playback-incapable content data items.

Hence, the user may easily recognize the presence of playback-incapable content data 221 by displaying the message 72 together with the list screen 71A. For example, if an identification information item of the content data 221 which the user intends to select is not displayed in the list screen 71A, the user may easily recognize that the corresponding item of the content data 221 which the user intends to select is incapable of being played back.

In this embodiment, the display process in which the identification information items of the content data 221 are displayed in the list screen is performed on the respective items of the content data 221 read from the storage area 220, based on the result of the determination of the playback capability on the display device 300. However, the present disclosure is not limited to this embodiment.

For example, the determination of the playback capability of all of the items of the content data 221 stored in the storage area 220 may be performed in advance by the playback capability determination unit 212. In this case, after the playback capability determination unit 212 processes all of the items of the content data 221, the display control unit 213 may extract the items of the content data 221 determined as being capable of being played back, and display the list screen including the corresponding thumbnail images.

In this embodiment, when a connection between the information terminal 200 and the display device 300 is established, the information terminal 200 receives the playback capability information 331 from the display device 300. However, the present disclosure is not limited to this embodiment. For example, the playback capability information 331 may be stored beforehand in the storage area 220 of the information terminal 200. In this case, upon starting of the selection control program 210, the playback capability information reception unit 211 may read the playback capability information 331 from the storage area 220.

Moreover, the display system 100 may be configured to include a first display device and a second display device having different playback capabilities. In this case, the information terminal 200 may be configured to include a playback capability information table in which identification information items to identify the first and second display devices respectively and playback capability information items of the first and second display devices are associated with each other.

Furthermore, the information terminal 200 may be configured to display a selection screen for prompting the user to select one of the display devices included in the display system 100, and receive the playback capability information 331 of the display device selected by making reference to the playback capability information table. In this case, the list screen of the identification information items of the playback-capable content data 223 corresponding to the selected display device is displayed on the information terminal 200. Moreover, in this case, the information terminal 200 may be configured to associate the received playback capability information 331 with device identification information to identify the selected display device, and store the playback capability information 331 associated with the device identification information in the playback capability information table.

In this embodiment, the list screen 71 is displayed by the display control unit 213 after the playback capability determination process is performed by the playback capability determination unit 212. However, the present disclosure is not limited to this embodiment. For example, the playback capability determination unit 212 may be configured to perform the playback capability determination process in response to a user's instruction received when the list screen of the content data 221 is displayed. In this case, the display control unit 213 may be configured to set the identification information items of the content data 221 determined as being incapable of being played back on the display device 300 by the playback capability determination unit 212 in a non-selectable condition or a non-display condition.

As described above, the information terminal 200 according to the first embodiment determines, when a content data list display instruction input by a user is received, whether the content data 221 stored in the storage area 220 is capable of being played back on the display device 300, and displays only the playback-capable content data 221 in the list screen. Namely, all the items of the content data 221 selected in the list screen 71 on the information terminal 200 are capable of being played back on the display device 300. Hence, it is possible for the display system 100 according to the first embodiment to supply increased operability in selection of the content data 221 while avoiding the case in which the content data 221 selected is incapable of being played back on the display device 300.

### Second Embodiment

Next, a display system according to a second embodiment is described. The display system according to the second embodiment differs from the display system according to the first embodiment in the list screen display process. In the following, only the points of the second embodiment different from the first embodiment are described, the elements in the second embodiment which are essentially the same as corresponding elements in the first embodiment are designated by the same reference numerals, and a description thereof is omitted.

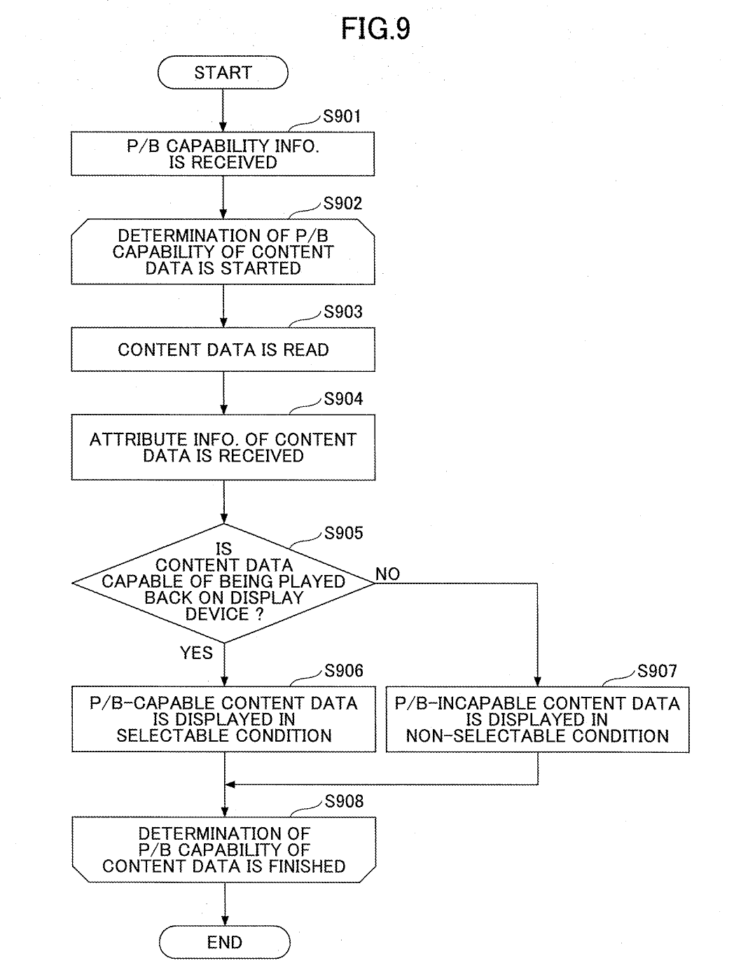

FIG. 9 is a flowchart for explaining a list screen display process performed by an information terminal of the display system according to the second embodiment.

Processing of steps S901 to S906 in the list screen display process of FIG. 9 is the same as the processing of steps S601 to S606 in the list screen display process of FIG. 6, and a description thereof is omitted.

In this embodiment, after the list of the identification information items of the content data 221 is displayed in the selectable condition at step S906, control progresses to step S908 which will be described later.

As shown in FIG. 9, when the playback capability determination unit 212 at step S905 determines that the content data 221 is incapable of being played back on the display device 300 (NO in step S905), the display control unit 213 is caused to display a list screen of the identification information items of the content data 221 in a non-selectable condition in which the identification information items in the list screen cannot be selected by the user (step S907).

When the list screen of the identification information items of the content data 221 in the non-selectable condition, a user's touch or a user's operation using a pointing device on one of the identification information items of the content data 221 in the list screen displayed in the viewing area is not detected as a selection instruction of a corresponding item of the content data 221.

Alternatively, the information terminal 200 may be configured so that, when the list screen of the identification information items of the content data 221 in the non-selectable condition, a user's touch or a user's operation using a pointing device in the list screen displayed in the viewing area is not detected.

Subsequently, the information terminal 200 finishes the determination of the playback capability of the content data 221 in the display process shown in FIG. 9 (step S908). The processing of steps S902 to S908 performed by the playback capability determination unit 212 and the display control unit 213 of the information terminal 200 is repeated for all the content data 221 stored in the storage area 220.

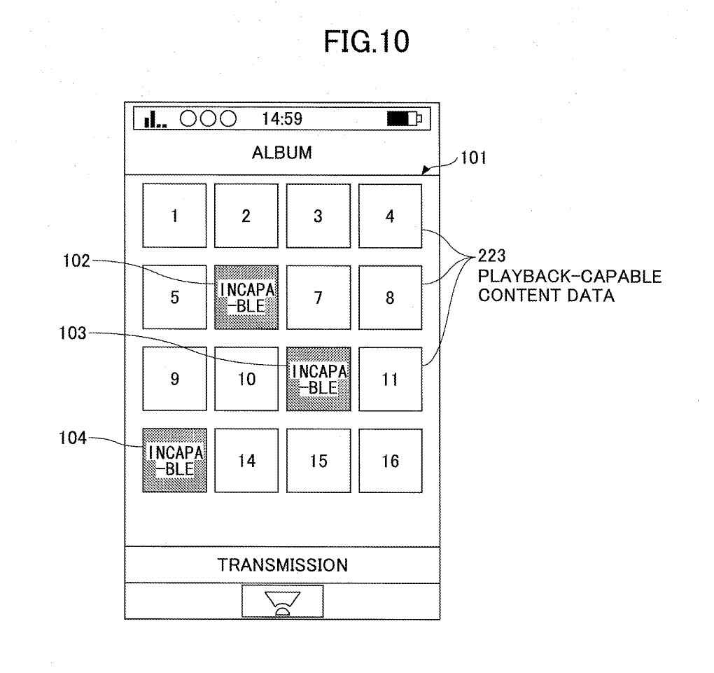

FIG. 10 shows a list screen 101 displayed on the information terminal according to the second embodiment.

As shown in FIG. 10, in the list screen 101, the identification information items of the playback-capable content data 223, which are determined as being capable of being played back on the display device 300 in the display process of FIG. 9, are displayed in the selectable condition. Moreover, in the list screen 101, identification information items 102, 103, 104 of the content data 221, which are determined as being incapable of being played back on the display device 300 in the display process of FIG. 9, are displayed in the non-selectable condition.

The display control unit 213 is configured to display the identification information items of the playback-capable content data 223 and the identification information items of the remaining, playback-incapable content data 221 in mutually different display modes.

In the list screen 101, when the identification information items of the playback-incapable content data 221 are displayed as thumbnail images 102, 103, 104, a message indicating that the content data is incapable of being played back may be overlapped on each of the thumbnail images 102, 103, 104. Alternatively, in the list screen 101, only the thumbnail images 102, 103, 104 may be displayed in a monochrome display mode.

In this embodiment, in the list screen 101, the identification information items of the playback-incapable content data 221 and the identification information items of the playback-capable content data 223 are displayed in mutually different display modes so that the user may easily recognize the playback-incapable content data 221 in the list screen 101.

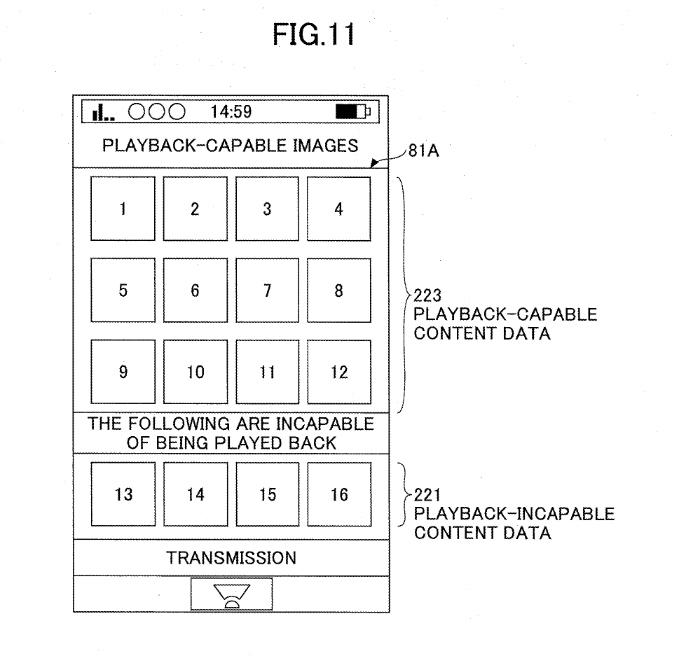

FIG. 11 shows a list screen 81A displayed on the information terminal according to the second embodiment.

The list of the identification information items of the content data 221 which are determined as being incapable of being played back may be displayed in the non-selectable condition in a viewing area different from the viewing area in which the list of the identification information items of the playback-capable content data 223 is displayed.

In this embodiment, the list of the identification information items of the playback-incapable content data 221 is displayed as shown in FIG. 11 so that the user may easily recognize which content data is incapable of being played back on the display device 300.

### Third Embodiment

Next, a display system according to a third embodiment is described. The display system according to the third embodiment differs from the display system 100 according to the first embodiment in that the playback capability information 331 is stored in a server over the network. In the following, only the points of the third embodiment different from the first embodiment are described, the elements in the third embodiment which are essentially the same as corresponding elements in the first embodiment are designated by the same reference numerals, and a description thereof is omitted.

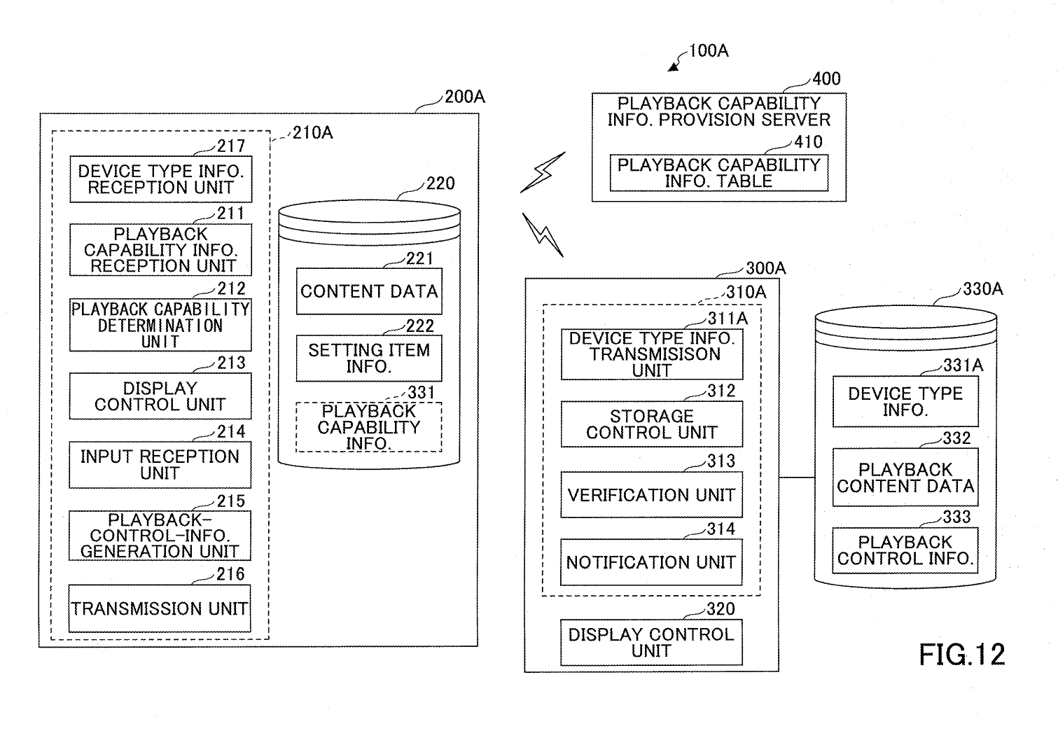

FIG. 12 shows a functional configuration of each of an information terminal 200A, a display device 300A, and a playback capability information provision server 400 of a display system 100A according to the third embodiment.

As shown in FIG. 12, the display system 100A includes the information terminal 200A, the display device 300A, and the playback capability information provision server 400. In this embodiment, a playback capability information table 410, in which device type information of the display device 300A and the playback capability information 331 which are associated with each other, is stored in the playback capability information provision server 400.

The playback capability information provision server 400 is provided over the network and configured to supply the information terminal 200A with the playback capability information 331 in response to a reception request of the playback capability information 331 transmitted by the information terminal 200A.

As shown in FIG. 12, a selection control program 210A is installed in the information terminal 200A. The information terminal 200A includes a device type information reception unit 217 in addition to the playback capability information reception unit 211, the playback capability determination unit 212, the display control unit 213, the input reception unit 214, the playback-control-information generation unit 215, and the transmission unit 216 as included in the information terminal 200 according to the first embodiment. The selection control program 210A when executed by a processor of the information terminal 200A causes the processor to serve as these functional units 211-217 of the information terminal 200A.

The device type information reception unit 217 is configured to send a reception request of device type information to the display device 300A and receive the device type information from the display device 300A.

Moreover, as shown in FIG. 12, a playback program 310A is installed in the display device 300A. The display device 300A includes a device type information transmission unit 311A in addition to the storage control unit 312, the verification unit 313, and the notification unit 314 as included in the display device 300 according to the first embodiment. The playback program 310A when executed by a processor of the display device 300A causes the processor to serve as these functional units 311A-314 of the display device 300A.

Moreover, the display device 300A includes a storage area 330A, and device type information 331A of the display device 300A to identify the display device 300A is stored in the storage area 330A. For example, the device type information 331A may include a device name and a product identifier which are used to identify the display device 300A. The device type information 331A is predetermined for the display device 300A.

The device type information transmission unit 311A is configured to read the device type information from the storage area 330A in response to a reception request of device type information transmitted by the information terminal 200A, and transmit the device type information from the device type information transmission unit 311A to the information terminal 200A.

In the display system 100A, if a content data list display instruction associated with the content data 221 input by a user is received at the information terminal 200A, the information terminal 200A causes the device type information reception unit 217 to receive the device type information of the display device 300A.

Subsequently, the information terminal 200A transmits a reception request of the playback capability information 331 to the playback capability information provision server 400 together with the device type information received by the playback capability information reception unit 211A.

In response to the reception request from the information terminal 200A, the playback capability information provision server 400 acquires playback capability information 331 corresponding to the device type information obtained from the information terminal 200A by making reference to the playback capability information table 410, and transmits the acquired playback capability information 331 to the information terminal 200A.

After the playback capability information 331 is received from the playback capability information provision server 400, the information terminal 200A causes the playback capability determination unit 212 to perform the playback capability determination in a manner similar to the processing of steps S602-S605 in FIG. 6 or steps S902-S906 in FIG. 9, and causes the display control unit 213 to perform the list screen display process in a manner similar to the processing of step S606 in FIG. 6 or steps S906-S907 in FIG. 9.

As described in the foregoing, it is possible for the display system according to the present invention to supply increased operability in selection of content data to be played back on a display device.

The display system according to the present invention is not limited to the above-described embodiments, and variations and modifications may be made without departing from the scope of the present invention.

The present application is based upon and claims the benefit of priority of Japanese Patent Application No. 2013-181154, filed on Sep. 2, 2013, the contents of which are incorporated herein by reference in their entirety.

What is claimed is:

1. A display system including a display device and an information terminal adapted to communicate with the display device, the information terminal including a processor and a storage part storing instructions which when executed by the processor cause the processor to perform a process comprising:
determining whether content data stored in the storage part is capable of being played back on the display device based on information associated with playback capability of the content data on the display device;
displaying a list screen of identification information items of content data when the content data is determined as being capable of being played back on the display device; and
transmitting, to the display device, content data corresponding to identification information items which are selected from the list screen displayed.

2. A non-transitory computer-readable recording medium storing instructions which, when executed by a processor of an information terminal adapted to communicate with a display device, causes the processor to perform a process comprising:
determining whether content data stored in a storage part of the information terminal is capable of being played back on the display device based on information associated with playback capability of the content data on the display device;
displaying a list screen of identification information items of first content data when the first content data is determined as being capable of being played back on the display device; and
transmitting, to the display device, second content data corresponding to identification information items which are selected from the list screen displayed.

3. The non-transitory computer-readable recording medium according to claim 2, wherein the displaying comprises:
displaying the identification information items of the first content data among the content data stored in the storage part when the first content data is determined as being capable of being played back on the display device; and
setting identification information items of the remaining content data, determined as being incapable of being played back on the display device, in a non-display condition.

4. The non-transitory computer-readable recording medium according to claim 2, wherein the displaying comprises:
displaying the identification information items of the first content data, among the content data stored in the storage part, determined as being capable of being played back on the display device in a selectable condition; and
displaying identification information items of the remaining content data determined as being incapable of being played back on the display device in a non-selectable condition.

5. The non-transitory computer-readable recording medium according to claim 2, wherein the information associated with the playback capability the content data includes at least one of information indicating a file type of content data capable of being played back on the display device and information indicating a file format of the content data capable of being played back on the display device.

6. The non-transitory computer-readable recording medium according to claim 2, wherein the process further comprises:
receiving the information associated with the playback capability of the content data from the display device, and
the determining comprises:
comparing attribute information of the content data with the information associated with the playback capability, and
determining that the content data is capable of being played back on the display device when the attribute information of the content data corresponds to the information associated with the playback capability.

7. The non-transitory computer-readable recording medium according to claim 2, wherein the process further comprises:
receiving device type information indicating a device type of the display device from the display device; and
acquiring playback capability information of the display device corresponding to the received device type information by making reference to a table in which the device type information and the playback capability information, associated with each other, are stored.

8. A selection control method for use in a display system including a display device and an information terminal adapted to communicate with the display device, the method comprising:
determining by the information terminal whether content data stored in a storage part of the information terminal is capable of being played back on the display device based on information associated with playback capability of the content data on the display device;
displaying by the information terminal a list screen of identification information items of first content data when the first content data is determined as being capable of being played back on the display device; and
transmitting by the information terminal, to the display device, second content data corresponding to identification information items which are selected from the list screen displayed.
